(19) United States
(12) Patent Application Publication
(10) Pub. No.: US 2012/0319034 A1
(43) Pub. Date: Dec. 20, 2012

(54) LITHIUM SECONDARY BATTERY ACTIVE MATERIAL AND LITHIUM SECONDARY BATTERY USING THE SAME

(75) Inventors: Hidekazu Awano, Tokyo (JP); Katsuyuki Negishi, Tokyo (JP)

(73) Assignee: Nippon Chemical Industrial Co., Ltd., Koto-ku, TOKYO (JP)

(21) Appl. No.: 13/511,807

(22) PCT Filed: Nov. 25, 2010
(86) PCT No.: PCT/JP2010/070987

§ 371 Date: Aug. 30, 2012

(30) Foreign Application Priority Data
Nov. 26, 2009 (JP) 2009-268786

(51) Int. Cl. H01M 4/485

(52) U.S. Cl. 252/182.1

(57) ABSTRACT

A lithium secondary battery active material in which lithium titanate that can supply excellent rapid charge and discharge characteristics to a lithium secondary battery when used as a negative electrode active material of the lithium secondary battery is used, and a lithium secondary battery that is manufactured using the lithium secondary battery active material and is excellent in terms of, particularly, rapid charge and discharge characteristics. The lithium secondary battery active material of the invention is composed of lithium titanate which has a spinel structure, has a content of sulfate radicals of 100 ppm to 2500 ppm in terms of sulfur atoms and a content of chlorine of 1500 ppm or less, and is expressed by a general formula LiₓTi_{y}O₁₂ (however, in the formula, the atomic ratio of Li/Ti is 0.70 to 0.90, x satisfies 3.0≦x≦5.0, and y satisfies 4.0≦y≦6.0).

### TECHNICAL FIELD

The present invention relates to a lithium secondary battery active material in which lithium titanate is used and a lithium secondary battery using the same.

### BACKGROUND ART

It is known that a lithium secondary battery in which Li₄Ti₅O₁₂ is used as an electrode active material among lithium titanates that are complex oxides of lithium and titanium has a voltage of approximately 1.55 V with respect to lithium, and the volume expansion during charging and discharging is small, and therefore the service life is long. Therefore, lithium titanate is a material that will gaining attention particularly in the fields of hybrid electric vehicles or large-scale batteries such as stationary batteries. In addition, lithium titanate can be used in positive electrodes and negative electrodes, but is particularly promising as a negative electrode active material.

A lithium secondary battery in which lithium titanate is used as a negative electrode active material has problems in that, particularly, rapid charge and discharge characteristics are poor, and high-temperature storage characteristics are also poor.

Therefore, an attempt is being made to improve the battery characteristics of a lithium secondary battery by using lithium titanate to which a third component has been added as an electrode active material.

As an example of such an attempt, A. D. Robertson et al. propose Li₁₊ₓFe₁₋₃ₓTi₁₊₂ₓO₄ (0.0≦x≦0.33) containing iron (Fe) (for example, refer to NPL 1). In addition, T. Ohzuku et al. propose Li[CrTi]O₄ containing chromium (Cr) (for example, refer to NPL 2).

In addition, in a metal-substituted lithium titanate, a method of manufacturing the same, and a lithium battery manufactured using the same, lithium titanate is used in which some of the lithium component is substituted with a metal having a valence of 2 or more, and at least one selected from a group consisting of cobalt, nickel, manganese, vanadium, iron, boron, aluminum, silicon, zirconium, strontium, magnesium, and tin is used as the metal that substitutes the lithium component (for example, refer to PTL 1).

In addition, a method of manufacturing lithium titanate containing a few impurities in which high-purity titanium oxide is used is proposed (for example, refer to PTL 2).

Furthermore, use of lithium titanate that contains sulfur and contains an alkali metals and/or an alkaline earths metal is proposed (for example, refer to PTL 3).

### CITATION LIST

### Patent Literature

[PTL 1] JP-A-10-251020
[PTL 2] JP-A-2000-302547
[PTL 3] JP-A-2004-235144

### Non-Patent Literature

[NPL 1] Journal of the Electrochemical Society, 146 (11) 3985-3962 (1991)
[NPL 2] Journal of the Electrochemical Society, 147 (10) 3592-3597 (2000)

### SUMMARY OF INVENTION

### Technical Problem

However, even when the above-mentioned lithium titanates are used, sufficient characteristics of a lithium secondary battery cannot be obtained, and, furthermore, there has been a demand for development of an electrode active material in which lithium titanate that can supply excellent rapid charge and discharge characteristics to a lithium secondary battery is used.

Therefore, an object of the invention is to provide a lithium secondary battery active material in which lithium titanate that can supply excellent rapid charge and discharge characteristics to a lithium secondary battery when used as a negative electrode active material of the lithium secondary battery is used, and a lithium secondary battery that is composed of the lithium secondary battery active material and is particularly excellent in terms of rapid charge and discharge characteristics.

### Solution to Problem

The present inventors have performed thorough studies in order to solve the above problems, and consequently, have found that a lithium secondary battery in which a negative electrode active material, which has a spinel structure, contains a specific range of sulfate radicals, substantially contains no chlorine, and is expressed by a general formula LiₓTi_{y}O₁₂ (however, in the formula, the atomic ratio of Li/Ti is 0.70 to 0.90, x satisfies 3.0≦x≦5.0, and y satisfies 4.0≦y≦6.0), is used is particularly excellent in terms of rapid charge and discharge characteristics, and have completed the invention.

That is, the lithium secondary battery active material of the invention is composed of lithium titanate which has a spinel structure, has a content of sulfate radicals of 100 ppm to 2500 ppm in terms of sulfur atoms and a content of chlorine of 1500 ppm or less, and is expressed by a general formula LiₓTi_{y}O₁₂ (however, in the formula, the atomic ratio of Li/Ti is 0.70 to 0.90, x satisfies 3.0≦x≦5.0, and y satisfies 4.0≦y≦6.0).

The lithium titanate preferably has a content of niobium of 50 ppm or more.

The lithium titanate preferably has an average particle diameter of 0.1 μm to 3.0 μm.

The lithium titanate preferably has a specific surface area by the BET method of 1.0 m²/g to 10.0 m²/g.

The lithium titanate is preferably generated by firing a mixture including a lithium compound and titanium dioxide obtained by a sulfuric acid method.

The lithium titanate is preferably generated by firing a mixture including a lithium compound, titanium dioxide obtained by a sulfuric acid method, and a sulfate of an alkaline earth metal.

The sulfate of an alkaline earth metal is preferably calcium sulfate or magnesium sulfate.

In the lithium secondary battery of the invention, the lithium secondary battery active material of the invention is used as a negative electrode active material.

### Advantageous Effects of Invention

According to the lithium secondary battery active material of the invention, since the lithium secondary battery active material is composed of lithium titanate which has a spinel structure, has a content of sulfate radicals of 100 ppm to 2500 ppm in terms of sulfur atoms and a content of chlorine of 1500 ppm or less, and is expressed by a general formula LiₓTi_{y}O₁₂ (however, in the formula, the atomic ratio of Li/Ti is 0.70 to 0.90, x satisfies 3.0≦x≦5.0, and y satisfies 4.0≦y≦6.0), it is possible to supply particularly excellent rapid charge and discharge characteristics to a lithium secondary battery in which the lithium secondary battery active material is used as a negative electrode active material.

### DESCRIPTION OF EMBODIMENTS

The best aspects of the lithium secondary battery active material of the invention and a lithium secondary battery using the same will be described.

Meanwhile, the aspects will be specifically described in order to help easy understanding of the purport of the invention, and, unless otherwise described, do not limit the invention.

(Lithium Secondary Battery Active Material)

The lithium secondary battery active material of the invention is composed of lithium titanate which has a spinel structure, and is expressed by a general formula LiₓTi_{y}O₁₂.

The spinel structure refers to an octahedral crystal structure which belongs to a cubic crystal system.

In the general formula, the atomic ratio of Li/Ti is 0.70 to 0.90, and more preferably 0.75 to 0.85.

A reason why the atomic ratio of Li/Ti is more preferably 0.75 to 0.85 is that the discharge capacity of a lithium secondary battery which is manufactured using the lithium secondary battery active material as an electrode active material is improved as long as the atomic ratio of Li/Ti is within the above range.

In addition, in the general formula, x satisfies 3.0≦x≦5.0, and more preferably satisfies 3.5≦x≦4.5.

A reason why x more preferably satisfies 3.5≦x≦4.5 is that a lithium secondary battery which is manufactured using the lithium secondary battery active material as an electrode active material has a discharge capacity that is close to a theoretical value as long as the value of x is within the above range.

Furthermore, in the general formula, y satisfies 4.0≦y≦6.0, and more preferably satisfies 4.5≦y≦5.5.

A reason why y more preferably satisfies 4.5≦≦y≦5.5 is that a lithium secondary battery which is manufactured using the lithium secondary battery active material as an electrode active material has a discharge capacity that is close to a theoretical value as long as the value of y is within the above range.

In the invention, the lithium titanate has a content of sulfate radicals of 100 ppm to 2500 ppm, and preferably 100 ppm to 2000 ppm in terms of sulfur (S) atoms.

Reasons why the lithium titanate has a content of sulfate radicals of 100 ppm to 2000 ppm in terms of sulfur atoms are that a lithium secondary battery which is manufactured using the lithium secondary battery active material as an electrode active material cannot obtain a sufficient rapid charge and discharge performance when the content of sulfate radicals is less than 100 ppm in terms of sulfur atoms, and, on the other hand, a lithium secondary battery which is manufactured using the lithium secondary battery active material as an electrode active material cannot obtain a sufficient discharge capacity even when the content of sulfate radicals exceeds 2500 ppm in terms of sulfur atoms.

In addition, the lithium titanate has a content of chlorine (Cl) of 1500 ppm or less, preferably 500 ppm or less, and particularly preferably 100 ppm or less, which implies the lithium titanate substantially contains no chlorine.

A reason why the lithium titanate has a content of chlorine of 1500 ppm or less is that, when the content of chlorine exceeds 1500 ppm, a lithium secondary battery which is manufactured using the lithium secondary battery active material as an electrode active material cannot obtain a sufficient rapid charge and discharge performance.

In addition, the lithium titanate has a content of niobium (Nb) of preferably 50 ppm or more, more preferably 150 ppm to 2000 ppm, and still more preferably 200 ppm to 2000 ppm.

A reason why the lithium titanate preferably has a content of niobium of 50 ppm or more is that a lithium secondary battery which is manufactured using the lithium secondary battery active material composed of the lithium titanate as a negative electrode active material can further improve the rapid charge and discharge performance.

In addition, the average particle diameter of the lithium titanate is preferably 0.1 μm to 3.0 μm, and more preferably 0.1 μm to 1.5 μm in terms of values obtained by the laser light scattering method.

A reason why the average particle diameter of the lithium titanate is preferably 0.1 μm to 3.0 μm in terms of values obtained by the laser light scattering method is that a lithium secondary battery which is manufactured using the lithium titanate as an electrode active material can obtain a sufficient rapid charge and discharge performance as long as the average particle diameter of the lithium titanate is within the above range.

Furthermore, the lithium titanate has a specific surface area by the BET method of preferably 1.0 m²/g to 10.0 m²/g, and more preferably 1.0 m²/g to 7.0 m²/g.

A reason why the specific surface area of the lithium titanate by the BET method is preferably 1.0 m²/g to 10.0 m²/g is that a lithium secondary battery which is manufactured using the lithium titanate as an electrode active material can obtain sufficient high-temperature storage characteristics as long as the specific surface area of the lithium titanate by the BET method is within the above range.

In addition, the lithium titanate is preferably generated by firing a mixture including a lithium compound and titanium dioxide obtained by a sulfuric acid method.

A lithium secondary battery which is manufactured using the lithium titanate as generated in the above manner as a negative electrode active material exhibits a particularly excellent rapid charge and discharge performance.

Furthermore, the lithium titanate is preferably generated by firing a mixture including a lithium compound, titanium dioxide obtained by a sulfuric acid method, and a sulfate of an alkaline earth metal.

A lithium secondary battery which is manufactured using the lithium titanate as generated in the above manner as a negative electrode active material has improved rapid charge and discharge performance.

Calcium sulfate or magnesium sulfate is used as the sulfate of an alkaline earth metal, and a lithium secondary battery which is manufactured using the lithium titanate generated using the sulfate as an electrode active material is also excellent in terms of high-temperature storage characteristics.

(Method of Manufacturing the Lithium Secondary Battery Active Material)

The lithium secondary battery active material of the invention can be industrially advantageously manufactured by using titanium dioxide which is obtained by a sulfuric acid method, has a content of sulfur of 100 ppm to 2500 ppm, and preferably 100 ppm to 2000 ppm, a content of chlorine of 1500 pm or less, preferably 500 ppm or less, and particularly preferably 100 ppm or less, and further preferably a content of niobium of 50 ppm or more, preferably 150 ppm to 2000 ppm, and more preferably 200 ppm to 2000 ppm in a method of manufacturing lithium titanate that is expressed by a general formula LiₓTi_{y}O₁₂ (however, in the formula, the atomic ratio of Li/Ti is 0.70 to 0.90, x satisfies 3.0≦x≦5.0, and y satisfies 4.0≦y≦6.0) by firing a mixture including a lithium compound and titanium dioxide.

The method of manufacturing the lithium secondary battery active material of the invention will be described in more detail.

Examples of the lithium compound that can be preferably used include lithium hydroxide, lithium carbonate, lithium nitrate, and other inorganic lithium compounds. Among the lithium compounds, lithium carbonate and lithium hydroxide are preferred since the two can be easily procured industrially and are cheap.

The average particle diameter of the lithium compound is a value obtained by the laser light scattering method, is preferably 1.0 μm to 20.0 μm, and more preferably 1.0 μm to 10.0 μm.

A reason why the average particle diameter of the lithium compound is preferably 1.0 μm to 10.0 μm in terms of a value obtained by the laser light scattering method is that the mixing properties with titanium dioxide are favorable.

Generally, titanium dioxide is industrially manufactured by a chloric acid method or a sulfuric acid method, and titanium dioxide manufactured by the sulfuric acid method is used in the invention. The sulfuric acid method in the method of manufacturing titanium dioxide refers to a method in which ilmenite ore (FeTiO₃), which is a raw material, is dissolved using a sulfuric acid, the titanium component is made into a soluble salt, then, hydrolyzed, the hydrolysate is precipitated as a metatitanic acid, which is a precursor of titanium dioxide, and the metatitanic acid is fired, thereby manufacturing titanium dioxide.

Sulfate radicals are irreversibly incorporated into the titanium dioxide as sulfur atoms during manufacturing, and the content thereof is preferably 100 ppm to 2500 ppm, and more preferably 100 ppm to 2000 ppm.

In addition, the titanium dioxide has a content of chlorine of 1500 ppm or less, preferably 500 ppm or less, and particularly preferably 100 ppm or less, and a titanium dioxide substantially containing no chlorine, in which the content of chlorine is 100 ppm or less, can be industrially easily procured.

Furthermore, the titanium dioxide has a content of niobium of preferably 50 ppm or more, and more preferably 50 ppm to 2000 ppm, and a titanium dioxide having a content of niobium of 50 ppm to 2000 ppm is commercially available.

The crystal structures of titanium dioxide are roughly classified into anatase type and rutile type, and any type can be used in the invention. However, due to favorable reactivity, anatase-type titanium dioxide containing 90% by mass or more of anatase type is particularly preferably used.

The average particle diameter of the titanium dioxide is preferably 3.0 μm or less, and more preferably 0.1 μm to 3.0 μm in terms of values obtained by the laser light scattering method.

A reason why the average particle diameter of the titanium dioxide is more preferably 0.1 μm to 3.0 μm in terms of values obtained by the laser light scattering method is that a lithium secondary battery manufactured using lithium titanate, which is manufactured using the titanium dioxide, as a negative electrode active material has improved rapid charge and discharge performance, as long as the average particle diameter of the titanium dioxide is within the above range.

In addition, the titanium dioxide that is preferably used has a specific surface area by the BET method of 1.0 m²/g to 50.0 m²/g, and more preferably 20.0 m²/g to 40.0 m²/g.

A reason why the titanium dioxide having a specific surface area by the BET method of 1.0 m²/g to 50.0 m²/g is preferably used is that a lithium secondary battery manufactured using lithium titanate, which is manufactured using the titanium dioxide, as an electrode active material has improved rapid charge and discharge performance as long as the specific surface area of the titanium dioxide by the BET method is within the above range.

As the method of mixing the lithium compound and the titanium dioxide, any method of a wet mixing method in which both materials are mixed in a solvent and a dry mixing method in which both materials are mixed without using a solvent can be used as long as a uniform mixture can be prepared.

In addition, the blending ratio of the lithium compound and the titanium dioxide is preferably 0.70 to 0.90, and more preferably 0.75 to 0.85 in terms of a molar ratio (Li/Ti) of lithium atoms in the lithium compound to titanium atoms in the titanium dioxide.

A reason why the blending ratio of the lithium compound and the titanium dioxide is preferably 0.70 to 0.90 in terms of a molar ratio (Li/Ti) of lithium atoms in the lithium compound to titanium atoms in the titanium dioxide is that a lithium secondary battery manufactured using lithium titanate, which is manufactured using the lithium compound and the titanium dioxide, as an electrode active material has improved discharge capacity as long as the blending ratio is within the above range. In addition, when the blending ratio of the lithium compound and the titanium dioxide is less than 0.70 in terms of the molar ratio (Li/Ti), rutile-type titanium dioxide remains in the lithium titanate, and a lithium secondary battery manufactured using the lithium titanate as an electrode active material cannot obtain a sufficient discharge capacity. On the other hand, when the blending ratio of the lithium compound and the titanium dioxide exceeds 0.90 in terms of the molar ratio (Li/Ti), Li₂TiO₃, which is a byproduct, is generated, and there is a tendency of the lithium secondary battery failing to obtain a sufficient discharge capacity.

In addition, a compound that serves as a sulfate radical and/or a compound that serves as a niobium source may also be further added to the mixture including the lithium compound and the titanium dioxide.

As the compound that serves as a sulfate radical, magnesium sulfate, calcium sulfate, aluminum sulfate, lithium sulfate, and other sulfates can be used. Among the above sulfates, magnesium sulfate or calcium sulfate are preferred since the high-temperature storage characteristics of a lithium secondary battery manufactured using lithium titanate, which is manufactured using the sulfate, as an electrode active material are excellent.

As the compound that serves as a niobium source, oxides of niobium, hydroxides, carbonates, nitrates, organic acid salts, and the like can be used.

In addition, instead of the compound that serves as a sulfate radical and the compound that serves as a niobium source, niobium sulfate may also be used as a compound that serves as a sulfate radical and a niobium source.

As the compound that serves as a sulfate radical and the compound that serves as a niobium source, fine compounds are preferably used since they can be uniformly mixed with raw materials (the lithium compound and the titanium dioxide).

Meanwhile, the added amounts of the compound that serves as a sulfate radical and the compound that serves as a niobium source need to satisfy the ranges of the content of the sulfate radicals, the content of chlorine, and, further preferably, the content of niobium in the lithium titanate.

Next, the mixture in which the raw materials are uniformly mixed is fired. The firing temperature is preferably set to 700° C. to 1000° C., and more preferably to 700° C. to 900° C.

Reasons why the firing temperature of the mixture is preferably set to 700° C. to 1000° C. are that, when the firing temperature is lower than 700° C., the lithium compound and the titanium dioxide do not react sufficiently, and, on the other hand, when the firing temperature exceeds 1000° C., the lithium titanate is sintered, and there is a tendency of the rapid charge and discharge performance of a lithium secondary battery in which the lithium titanate is used as a negative electrode active material being impaired.

In addition, the firing time is preferably 1 hour or more, and more preferably 1 hour to 10 hours.

Furthermore, the firing atmosphere is not particularly limited, and a reaction precursor can be fired in the atmosphere, an oxygen atmosphere, or an inert gas atmosphere.

In the invention, firing can be carried out as many times as desired. In addition, in order to uniform powder characteristics, the mixture may be fired one more time after being fired and crushed.

In addition, after the firing, the mixture is appropriately cooled, subjected to a crushing treatment according to necessity, and classified, thereby producing lithium titanate.

Meanwhile, the crushing treatment that is carried out according to necessity is appropriately carried out in a case in which the lithium titanate obtained through firing is brittle, combined block-shaped articles, but the particles of the lithium titanate have the following average particle diameter and specific surface area by the BET method. That is, the obtained lithium titanate has an average particle diameter of 0.1 μm to 3.0 μm, and preferably 0.1 μm to 1.5 μm, and a specific surface area by the BET method of preferably 1.0 m²/g to 10.0 m²/g, and more preferably 1.0 m²/g to 7.0 m²/g.

The lithium secondary battery active material of the invention can be used for any of a positive electrode active material and a negative electrode active material, but a lithium secondary battery in which the lithium secondary battery active material is used as a negative electrode active material exhibits particularly excellent rapid charge and discharge characteristics.

(Lithium Secondary Battery)

The lithium secondary battery of the invention is manufactured using the lithium secondary battery active material of the invention, and is composed of a positive electrode, a negative electrode, a separator, and a non-aqueous electrolyte containing a lithium salt.

The negative electrode is formed through coating, drying, and the like of an electrode binder (negative electrode binder) that is prepared by arbitrarily adding a conducting agent, a binding agent, or the like to the lithium titanate in the lithium secondary battery active material of the invention on a negative electrode collector.

The content of the lithium secondary battery active material in the electrode binder as the negative electrode active material is preferably 70% by weight to 100% by weight, and more preferably 90% by weight to 98% by weight.

The conducting binder is not particularly limited as long as the conducting binder is an electron transferring material that does not cause a chemical change in the composed battery, and examples thereof include graphite, such as natural graphite and artificial graphite; carbon blacks, such as carbon black, acetylene black, ketjen black, channel black, furnace black, lamp black, and thermal black; conductive fibers, such as carbon fibers and metal fibers; metal powder, such as carbon fluoride, aluminum, and nickel powder; conductive whiskers, such as zinc oxide and potassium titanate; conductive metallic oxides, such as titanium oxide; and conductive materials, such as polyphenylene derivatives.

Examples of natural graphite include scaly graphite, scale-like graphite, earthy graphite, and the like.

The conducting agent can be used singly or in combination of two or more kinds.

In addition, the blending ratio of the conducting agent in the negative electrode binder is preferably 1% by weight to 50% by weight, and more preferably 2% by weight to 30% by weight.

Examples of the binding agent include polysaccharides, such as starch, polyvinylidene fluoride, polyvinyl alcohol, carboxymethyl cellulose, hydroxylpropyl cellulose, regenerated cellulose, diacetyl cellulose, polyvinyl pyrrolidone, tetrafluoroethylene, polyethylene, polypropylene, ethylene propylene diene monomer (EPDM), sulfonated EPDM, styrene butadiene rubber, fluorine rubber, tetrafluoroethylene-hexafluoroethylene copolymers, tetrafluoroethylene-hexafluoropropylene copolymers, tetrafluoroethylene-perfluoroalkyl vinyl ether copolymers, vinylidene fluoride-hexafluoropropylene copolymers, vinylidene fluoride-chlorotrifluoroethylene copolymers, ethylene-tetrafluoroethylene copolymers, polychlorotrifluoroethylene, vinylidene fluoride-pentafluoropropylene copolymers, propylene-tetrafuloroethylene copolymers, ethylene-chlorotrifluoroethylene copolymers, vinylidene fluoride-hexafluoropropylene-tetrafluoroethylene copolymers, vinylidene fluoride-perfluoromethyl vinyl ether-tetrafluoroethylene copolymers, ethylene-acrylate copolymers or sodium ion (Na⁺)-crosslinked ethylene-acrylate copolymers, ethylene-methacrylate copolymers or sodium ion (Na⁺)-crosslinked ethylene-methacrylate copolymers, ethylene-methyl acrylate copolymers or sodium ion (Na⁺)-crosslinked ethylene-methyl acrylate copolymers, ethylene-methyl methacrylate copolymers or sodium ion (Na⁺)-crosslinked ethylene-methyl methacrylate copolymers, polyethylene oxides, thermoplastic resins, polymers having rubber elasticity, and the like. The binding agent can be used singly or in a combination of two or more kinds.

The negative electrode collector is not particularly limited as long as the negative electrode collector is an electron transferring material that does not cause a chemical change in the composed battery, and examples thereof include collectors obtained by carrying out a surface treatment using carbon, nickel, titanium, silver, or the like on a surface of a metal sheet, such as stainless steel, nickel, copper, titanium, aluminum, fired carbon, copper, or stainless copper, aluminum and cadmium alloys, and the like.

In addition, the materials may be used with the surfaces oxidized, or may be used with recesses and protrusions provided on the surfaces of the collectors through the surface treatment.

In addition, the forms of the collector include, for example, a foil, a film, a sheet, a net, a punched form, a glass body, a porous body, a foam body, a fibrous group, a non-woven molded body, and the like.

The thickness of the collector is not particularly limited, and is preferably 1 μm to 500 μm.

The positive electrode is formed by, for example, coating, drying, and the like of a positive electrode binder on the positive electrode collector.

The positive binder is composed of a positive electrode active material, the conducting agent, the binding agent, a filler that is added according to necessity, and the like.

As the positive electrode active material, one or two or more kinds of lithium complex oxides that are expressed by the following general formula (1) are used.

LiₐM_{1-b}A_{b}O_{c} (1)

However, in the formula (1), M represents one or more kinds of transition metal elements selected from cobalt (Co) or nickel (Ni), A represents one or two or more kinds of metal elements selected from a group consisting of magnesium (Mg), aluminum (Al), manganese (Mn), titanium (Ti), zirconium (Zr), iron (Fe), copper (Cu), zinc (Zn), tin (Sn), and indium (In), a satisfies 0.9≦a≦1.1, b satisfies 0≦b≦0.5, and c satisfies 1.8≦c≦2.2

The lithium complex oxides that are expressed by the above general formula (1) are not particularly limited, and examples thereof include LiCoO₂, LiNiO₂, LiNi_{0.8}Co_{0.2}O₂, LiNi_{0.8}CO_{0.1}Mn_{0.1}O₂, LiNi_{0.4}Co₀₃Mn_{0.3}O₂, LiNi_{0.33}CO_{0.33}Mn_{0.33}O₂, and the like.

The average particle diameters of the lithium complex oxide is preferably 1.0 μm to 30 μm, and more preferably 3.0 μm to 20 μm in terms of values obtained by the laser light scattering method.

A reason why the average particle diameter of the lithium complex oxide is preferably 1.0 μm to 30 μm in terms of values obtained by the laser light scattering method is that polarization or poor conducting can be suppressed in the positive electrode which is manufactured using the lithium complex oxide as long as the average particle diameter of the lithium complex oxide is within the above range.

In addition, the lithium complex oxide has a specific surface area by the BET method of 0.1 m²/g to 2.0 m²/g, and more preferably 0.2 m²/g to 1.0 m²/g.

A reason why the lithium complex oxide preferably has a specific surface area by the BET method of 0.1 m²/g to 2.0 m²/g is that the thermal stability of a lithium secondary battery having a positive electrode manufactured using the lithium complex oxide improves as long as the specific surface area of the lithium complex oxide by the BET method is within the above range.

The content of the positive electrode active material in the electrode binder is preferably 70% by weight to 100% by weight, and more preferably 90% by weight to 98% by weight.

The positive electrode collector is not particularly limited as long as the positive electrode collector is an electron transferring material that does not cause a chemical change in the composed battery, and examples thereof include collectors obtained by carrying out a surface treatment using carbon, nickel, titanium, silver, or the like on a surface of a metal sheet, such as stainless steel, nickel, copper, titanium, aluminum, fired carbon, copper, or stainless copper.

In addition, the materials may be used with the surfaces oxidized, or may be used with recesses and protrusions provided on the surfaces of the collectors through the surface treatment.

In addition, the forms of the collector include, for example, a foil, a film, a sheet, a net, a punched form, a glass body, a porous body, a foam body, a fibrous group, a non-woven molded body, and the like.

The thickness of the collector is not particularly limited, and is preferably 1 μm to 500 μm.

The collector is not particularly limited as long as the collector is an electron transferring material that does not cause a chemical change in the composed battery, and examples thereof include graphite, such as natural graphite and artificial graphite; carbon blacks, such as carbon black, acetylene black, ketjen black, channel black, furnace black, lamp black, and thermal black; conductive fibers, such as carbon fibers and metal fibers; metal powder, such as carbon fluoride, aluminum, and nickel powder; conductive whiskers, such as zinc oxide and potassium titanate; conductive metallic oxides, such as titanium oxide; and conductive materials, such as polyphenylene derivatives.

Examples of the natural graphite include scaly graphite, scale-like graphite, earthy graphite, and the like.

The conducting agent can be used singly or in combination of two or more kinds.

In addition, the blending ratio of the conducting agent in the positive electrode binder is preferably 1% by weight to 50% by weight, and more preferably 2% by weight to 30% by weight.

Examples of the binding agent include polysaccharides, such as starch, polyvinylidene fluoride, polyvinyl alcohol, carboxymethyl cellulose, hydroxylpropyl cellulose, regenerated cellulose, diacetyl cellulose, polyvinyl pyrrolidone, tetrafluoroethylene, polyethylene, polypropylene, ethylene propylene diene monomer (EPDM), sulfonated EPDM, styrene butadiene rubber, fluorine rubber, tetrafluoroethylene-hexafluoroethylene copolymers, tetrafluoroethylene-hexafluoropropylene copolymers, tetrafluoroethylene-perfluoroalkyl vinyl ether copolymers, vinylidene fluoride-hexafluoropropylene copolymers, vinylidene fluoride-chlorotrifluoroethylene copolymers, ethylene-tetrafluoroethylene copolymers, polychlorotrifluoroethylene, vinylidene fluoride-pentafluoropropylene copolymers, propylene-tetrafuloroethylene copolymers, ethylene-chlorotrifluoroethylene copolymers, vinylidene fluoride-hexafluoropropylene-tetrafluoroethylene copolymers, vinylidene fluoride-perfluoromethyl vinyl ether-tetrafluoroethylene copolymers, ethylene-acrylate copolymers or sodium ion (Na⁺)-crosslinked ethylene-acrylate copolymers, ethylene-methacrylate copolymers or sodium ion (Na⁺)-crosslinked ethylene-methacrylate copolymers, ethylene-methyl acrylate copolymers or sodium ion (Na⁺)-crosslinked ethylene-methyl acrylate copolymers, ethylene-methyl methacrylate copolymers or sodium ion (Na⁺)-crosslinked ethylene-methyl methacrylate copolymers, polyethylene oxides, thermoplastic resins, polymers having rubber elasticity, and the like. The binding agent can be used singly or in combination of two or more kinds.

When the compound composed of functional groups such as polysaccharide which react with lithium is used, it is preferable that the compound containing an isocyanate group be added and the functional group be deactivated.

In addition, the blending ratio of the conducting agent in the positive electrode binder is preferably 1% by weight to 50% by weight, and more preferably 5% by weight to 15% by weight.

Furthermore, a filler may be added to the positive electrode binder according to necessity in order to suppress the volume expansion and the like of the positive electrode.

The filler is not particularly limited as long as the filler is a fibrous material that does not cause a chemical change in the composed battery, and examples thereof that can be used include fibers composed of an olefin-based polymer, such as polypropylene or polyethylene, glass fibers, carbon fibers, and the like.

The amount of the filler added is not particularly limited, but is preferably 30% by weight or less in the positive electrode binder.

As the separator, an insulating thin film having a large ion permeability and a predetermined mechanical strength can be used.

As such a separator, an olefin-based polymer, such as polypropylene, a glass fiber, or a sheet or non-woven fabric composed of polyethylene or the like can be used in terms of organic solvent resistance and hydrophobicity.

The pore diameter of the separator is not particularly limited as long as the pore diameter is within a range that is generally useful for batteries, and is, for example, 0.01 μm to 10 μm.

The thickness of the separator is not particularly limited as long as the pore diameter is within a range that is generally useful for batteries, and is, for example, 5 μm to 300 μm. Meanwhile, in a case in which a solid electrolyte, such as a polymer, is used as an electrolyte as described below, the solid electrolyte may also function as the separator.

The non-aqueous electrolyte containing the lithium salt includes the non-aqueous electrolyte and the non-aqueous electrolyte.

As the non-aqueous electrolyte, a non-aqueous electrolytic solution, an organic solid electrolyte, or an inorganic solid electrolyte can be used.

Examples of the non-aqueous electrolytic solution include solvents in which one or two or more kinds selected from a group of non-protonic organic solvents, such as N-methyl-2-pyrrolidone, propylene carbonate, ethylene carbonate, butylene carbonate, dimethyl carbonate, diethyl carbonate, γ-butylolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl nitrate, trimester phosphate, trimethoxymethane, dioxolane derivatives, sulfolane, methylsulfolane, 3-methyl-2-oxazolidinone, 1,3-dimethyl-2-imidzolidinone, propylene carbonate derivatives, tetrahydrofuran derivatives, diethyl ether, 1,3-propan salton, methyl propionate, and ethyl propionate.

In addition, in order to improve the discharge and charge characteristics, and the flame resistance, a compound as shown below can be added to the non-aqueous electrolyte. Examples thereof include pyridine, triethyl phosphite, triethanolamine, cyclic ethers, ethylenediamine, n-glyme, hexaphosphoric triamide, a nitrobenzene derivative, sulfur, quinone imine dye, N-substituted oxazolidinone, N,N-substituted imidazolidine, ethylene glycol dialkyl ether, an ammonium salt, polyethyleneglycol, pyrrole, 2-methoxyethanol, aluminum trichloride, a monomer for a conductive polymer electrode active material, triethylene phosphonamide, trialkylphosphine, morpholine, an aryl compound having a carbonyl group, hexamethylphosphoric triamide, 4-alkyl morpholine, a bicyclic tertiary amine, oil, a phosphonium salt, a tertiary sulfonium salt, phosphazene, a carbonate, and the like.

In order to make the electrolytic solution flame-resistant, a halogen-containing solvent, such as carbon tetrachloride and ethylene trifluoride, can be further added to the electrolytic solution.

In addition, in order to make the electrolytic solution proper for high-temperature storage, carbon dioxide can be added to the electrolytic solution.

Examples of the organic solid electrolyte include a polymer containing an ionic dissociable group, such as a polyethylene derivative, a polyethylene oxide derivative, a polymer containing the above, a polypropylene oxide derivative, a polymer containing the above, a phosphoric ester polymer, polyphosphazene, polyaziridine, polyethylene sulfide, polyvinyl alcohol, polyvinylidene fluoride, and polyhexafluoropropylene, and a mixture of a polymer containing an ionic dissociable group and the non-aqueous electrolytic solution.

As the inorganic solid electrolyte, a nitride, halide, oxyacid salt, sulfide, or the like of lithium (Li) can be used, and examples thereof include Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, P₂S₅, Li₂S or Li₂S—P₂S₅, Li₂S—SiS₂, Li₂S—GeS₂, Li₂S—Ga₂S₃, Li₂S—B₂S₃, Li₂S—P₂S₅—X, Li₂S—SiS₂—X, Li₂S—GeS₂—X, Li₂S—Ga₂S₃—X, Li₂S—B₂S₃—X, (in which X represents at least one kind selected from LiI, B₂S₃, and Al₂S₃).

Furthermore, in a case in which the inorganic solid electrolyte is an amorphous material (glass), a compound containing oxygen, such as lithium phosphate (Li₃PO₄), lithium oxide (Li₂O), lithium sulfate (Li₂SO₄), phosphorus oxide (P₂O₅), and lithium borate (Li₃BO₃); or a compound containing nitrogen, such as Li₃PO₄₋ₓN_{2x/3} (x satisfies 0<x<4), Li₄SiO₄₋ₓN_{2x/3} (x satisfies 0<x<4), Li₄GeO₄₋ₓN_{2x/3} (x satisfies 0<x<4), and Li₃BO₃₋ₓN_{2x/3} (x satisfies 0<x<3), can be included in the inorganic solid electrolyte. Addition of a compound containing oxygen or a compound containing nitrogen can widen voids in an amorphous skeleton to be formed, reduce hindrance to the movement of lithium ions, and, furthermore, improve ion conductivity.

As the lithium salt, a material which is soluble in the above non-aqueous electrolyte is used, and examples thereof include salts in which one or two or more kinds selected from a group consisting of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiB₁₀Cl₁₀, LiAlCl₄, CH₃SO₃Li, CF₃SO₃Li, (CF₃SO₂)₂NLi, chloroborane lithium, lower aliphatic carboxylic acid lithium, 4-phenyl lithium borate, and imides are mixed.

The lithium secondary battery of the invention is a lithium secondary battery that is excellent in terms of battery performance, particularly, cycle characteristics, and the shape of the battery may be any shape of a button, a sheet, a cylinder, an angle, or a coin.

In addition, uses of the lithium secondary battery of the invention are not particularly limited, and the lithium secondary battery can be preferably used for hybrid electric vehicles (HEV), and large-scale stationary and other batteries. In addition, the lithium secondary battery can also be preferably used for, for example, electronic devices, such as notebooks, laptop computers, pocket word processors, mobile phones, cordless handsets, portable CD players, radios, liquid crystal televisions, backup power supplies, electric shavers, memory cards, video cameras, and household electronic appliances, such as game devices.

### EXAMPLES

Hereinafter, the invention will be described more specifically using examples and comparative examples, but the invention is not limited to the following examples.

Titanium Dioxide Samples

As titanium dioxide, commercially available titanium dioxides as shown in Table 1 were used.

Meanwhile, the average particle diameter was obtained by the laser light scattering method. The anatase-type titanium dioxides that were used in the examples had a content of anatase-type titanium dioxide of at least 90% by weight.

In addition, the contents of sulfur atoms and niobium in the titanium dioxides were measured by inductively coupled plasma atomic emission spectroscopy (ICP-AES) after the samples were dissolved using an acid. In addition, the contents of chlorine in the titanium dioxides were measured by X-ray fluorescence analysis.

TABLE 1

| | | | Average | BET specific | Content of | Content of | Content of |
|---|---|---|---|---|---|---|---|
| | Manufacturing | | particle | surface area | sulfur | chlorine | niobium |
| | method | Crystal type | diameter (μm) | (m²/g) | (ppm) | (ppm) | (ppm) |
| Sample A | Sulfuric acid | Anatase type | 1.1 | 28.2 | 138 | 20 | 51 |
| | method | | | | | | |
| Sample B | Sulfuric acid | Rutile type | 0.5 | 24.1 | 538 | 15 | 595 |
| | method | | | | | | |
| Sample C | Sulfuric acid | Anatase type | 1.2 | 30.8 | 1380 | 60 | 1731 |
| | method | | | | | | |
| Sample D | Sulfuric acid | Anatase type | 1.1 | 28.4 | 138 | 20 | 220 |
| | method | | | | | | |
| Sample E | Chloric acid | Anatase type | 0.62 | 52.3 | 12 | 3012 | 268 |
| | method | | | | | | |
| Sample F | Sulfuric acid | Rutile type | 0.48 | 18.9 | 2818 | 501 | 501 |
| | method | | | | | | |
| Sample G | Sulfuric acid | Anatase type | 1.2 | 30.8 | 1380 | 1821 | 1731 |
| | method | | | | | | |

### Example 1

Titanium dioxide (Sample A as shown in Table 1) and lithium carbonate (Li₂CO₂, average particle diameter of 8.2 μm) were blended so that the molar ratio (Li/Ti) of lithium atoms in the lithium carbonate to titanium atoms in the titanium dioxide was 0.800, and dry-mixed using a mixer, thereby preparing a uniform mixture.

Next, the mixture was fired at 700° C. for 10 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 1 are shown in Table 2.

### Example 2

Titanium dioxide (Sample A as shown in Table 1) and lithium hydroxide (LiOH.H₂O, average particle diameter of 3.6 μm) were blended so that the molar ratio (Li/Ti) of lithium atoms in the lithium hydroxide to titanium atoms in the titanium dioxide became 0.805, and dry-mixed using a mixer, thereby preparing a uniform mixture.

Next, the mixture was fired at 750° C. for 8 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 2 are shown in Table 2.

### Example 3

Titanium dioxide (Sample A as shown in Table 1) and lithium carbonate (Li₂CO₃, average particle diameter of 8.2 μm) were blended so that the molar ratio (Li/Ti) of lithium atoms in the lithium carbonate to titanium atoms in the titanium dioxide became 0.792, and dry-mixed using a mixer, thereby preparing a uniform mixture.

Next, the mixture was fired at 800° C. for 8 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 3 are shown in Table 2.

### Example 4

Titanium dioxide (Sample B as shown in Table 1) and lithium hydroxide (LiOH.H₂O, average particle diameter of 3.6 μm) were blended so that the molar ratio (Li/Ti) of lithium atoms in the lithium hydroxide to titanium atoms in the titanium dioxide became 0.805, and dry-mixed using a mixer, thereby preparing a uniform mixture.

Next, the mixture was fired at 720° C. for 10 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 4 are shown in Table 2.

### Example 5

Titanium dioxide (Sample B as shown in Table 1) and lithium carbonate (Li₂CO₂, average particle diameter of 8.2 μm) were blended so that the molar ratio (Li/Ti) of lithium atoms in the lithium carbonate to titanium atoms in the titanium dioxide became 0.800, and dry-mixed using a mixer, thereby preparing a uniform mixture.

Next, the mixture was fired at 750° C. for 5 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 5 are shown in Table 2.

### Example 6

Titanium dioxide (Sample B as shown in Table 1) and lithium hydroxide (LiOH.H₂O, average particle diameter of 3.6 μm) were blended so that the molar ratio (Li/Ti) of lithium atoms in the lithium hydroxide to titanium atoms in the titanium dioxide became 0.803, and dry-mixed using a mixer, thereby preparing a uniform mixture.

Next, the mixture was fired at 800° C. for 7 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 6 are shown in Table 2.

### Example 7

Titanium dioxide (Sample C as shown in Table 1) and lithium carbonate (Li₂CO₃, average particle diameter of 8.2 μm) were blended so that the molar ratio (Li/Ti) of lithium atoms in the lithium carbonate to titanium atoms in the titanium dioxide became 0.805, and dry-mixed using a mixer, thereby preparing a uniform mixture.

Next, the mixture was fired at 720° C. for 10 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 7 are shown in Table 2.

### Example 8

Titanium dioxide (Sample C as shown in Table 1) and lithium carbonate (Li₂CO₃, average particle diameter of 8.2 μm) were blended so that the molar ratio (Li/Ti) of lithium atoms in the lithium carbonate to titanium atoms in the titanium dioxide became 0.805, and dry-mixed using a mixer, thereby preparing a uniform mixture.

Next, the mixture was fired at 760° C. for 8 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 8 are shown in Table 2.

### Example 9

Titanium dioxide (Sample C as shown in Table 1) and lithium hydroxide (LiOH.H₂O, average particle diameter of 3.6 μm) were blended so that the molar ratio (Li/Ti) of lithium atoms in the lithium hydroxide to titanium atoms in the titanium dioxide became 0.795, and dry-mixed using a mixer, thereby preparing a uniform mixture.

Next, the mixture was fired at 800° C. for 5 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₄₂ having a spinel structure.

In addition, the manufacturing conditions of Example 9 are shown in Table 2.

### Example 10

Titanium dioxide (Sample D as shown in Table 1) and lithium carbonate (Li₂CO₃, average particle diameter of 8.2 μm) were blended so that the molar ratio (Li/Ti) of lithium atoms in the lithium carbonate to titanium atoms in the titanium dioxide became 0.800, furthermore, calcium sulfate (CaSO₄, average particle diameter of 50 μm) was added so as to obtain the content of sulfur as shown in Table 1, and the mixture was dry-mixed using a mixer, thereby preparing a uniform mixture.

Next, the mixture was fired at 720° C. for 10 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 10 are shown in Table 2.

### Example 11

Titanium dioxide (Sample D as shown in Table 1) and lithium carbonate (Li₂CO₂, average particle diameter of 8.2 μm) were blended so that the molar ratio (Li/Ti) of lithium atoms in the lithium carbonate to titanium atoms in the titanium dioxide became 0.803, furthermore, magnesium sulfate (MgSO₄, average particle diameter of 50 μm) was added so as to obtain the content of sulfur as shown in Table 1, and the mixture was dry-mixed using a mixer, thereby preparing a uniform mixture.

Next, the mixture was fired at 800° C. for 8 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₄₂ having a spinel structure.

In addition, the manufacturing conditions of Example 11 are shown in Table 2.

### Example 12

Titanium dioxide (Sample D as shown in Table 1) and lithium hydroxide (LiOH.H₂O, average particle diameter of 3.6 μm) were blended so that the molar ratio (Li/Ti) of lithium atoms in the lithium hydroxide to titanium atoms in the titanium dioxide became 0.795, and dry-mixed using a mixer, thereby preparing a uniform mixture.

Next, the mixture was fired at 800° C. for 5 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Example 12 are shown in Table 2.

### Comparative Example 1

Titanium dioxide (Sample E as shown in Table 1) and lithium carbonate (Li₂CO₃, average particle diameter of 8.2 μm) were blended so that the molar ratio (Li/Ti) of lithium atoms in the lithium carbonate to titanium atoms in the titanium dioxide became 0.800, and dry-mixed using a mixer, thereby preparing a uniform mixture.

Next, the mixture was fired at 780° C. for 10 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Comparative example 1 are shown in Table 2.

### Comparative Example 2

Titanium dioxide (Sample E as shown in Table 1) and lithium hydroxide (LiOH.H₂O, average particle diameter of 3.6 μm) were blended so that the molar ratio (Li/Ti) of lithium atoms in the lithium hydroxide to titanium atoms in the titanium dioxide became 0.800, and dry-mixed using a mixer, thereby preparing a uniform mixture.

Next, the mixture was fired at 730° C. for 5 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Comparative example 2 are shown in Table 2.

### Comparative Example 3

Titanium dioxide (Sample F as shown in Table 1) and lithium carbonate (Li₂CO₂, average particle diameter of 8.2 μm) were blended so that the molar ratio (Li/Ti) of lithium atoms in the lithium carbonate to titanium atoms in the titanium dioxide became 0.800, and dry-mixed using a mixer, thereby preparing a uniform mixture.

Next, the mixture was fired at 800° C. for 6 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Comparative example 3 are shown in Table 2.

### Comparative Example 4

Titanium dioxide (Sample F as shown in Table 1) and lithium hydroxide (LiOH.H₂O, average particle diameter of 3.6 μm) were blended so that the molar ratio (Li/Ti) of lithium atoms in the lithium hydroxide to titanium atoms in the titanium dioxide became 0.800, and dry-mixed using a mixer, thereby preparing a uniform mixture.

Next, the mixture was fired at 850° C. for 5 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Comparative example 4 are shown in Table 2.

### Comparative Example 5

Titanium dioxide (Sample G as shown in Table 1) and lithium hydroxide (LiOH.H₂O, average particle diameter of 3.6 μm) were blended so that the molar ratio (Li/Ti) of lithium atoms in the lithium hydroxide to titanium atoms in the titanium dioxide became 0.805, and dry-mixed using a mixer, thereby preparing a uniform mixture.

Next, the mixture was fired at 720° C. for 5 hours in the atmosphere.

After cooling, the fired mixture was subjected to a crushing treatment and then classification.

The classified crushed mixture was confirmed using an X-ray diffractometer (XRD), and it was confirmed that the crushed mixture was Li₄Ti₅O₁₂ having a spinel structure.

In addition, the manufacturing conditions of Comparative example 5 are shown in Table 2.

TABLE 2

| | Type of | Type of | Incorporation | Firing |
|---|---|---|---|---|
| | titanium | lithium | ratio of | temperature |
| | source | source | Li/Ti | (° C.) |
| Example 1 | Sample A | Li₂CO₃ | 0.8 | 720 |
| Example 2 | Sample A | LiOH•H₂O | 0.805 | 750 |
| Example 3 | Sample A | Li₂CO₃ | 0.792 | 800 |
| Example 4 | Sample B | LiOH•H₂O | 0.805 | 720 |
| Example 5 | Sample B | Li₂CO₃ | 0.8 | 750 |
| Example 6 | Sample B | LiOH•H₂O | 0.803 | 800 |
| Example 7 | Sample C | Li₂CO₃ | 0.805 | 720 |
| Example 8 | Sample C | Li₂CO₃ | 0.805 | 760 |
| Example 9 | Sample C | LiOH•H₂O | 0.795 | 800 |
| Example 10 | Sample D | Li₂CO₃ | 0.8 | 720 |
| Example 11 | Sample D | LiOH•H₂O | 0.803 | 800 |
| Example 12 | Sample D | Li₂CO₃ | 0.8 | 720 |
| Comparative | Sample E | Li₂CO₃ | 0.8 | 780 |
| example 1 | | | | |
| Comparative | Sample E | LiOH•H₂O | 0.8 | 730 |
| example 2 | | | | |
| Comparative | Sample F | Li₂CO₃ | 0.8 | 800 |
| example 3 | | | | |
| Comparative | Sample F | LiOH•H₂O | 0.8 | 850 |
| example 4 | | | | |
| Comparative | Sample G | Li₂CO₃ | 0.805 | 720 |
| example 5 | | | | |

Evaluation of the Property of the Lithium Titanate

For the lithium titanates obtained in Examples 1 to 12 and Comparative examples 1 to 5, the average particle diameters, the specific surface areas by the BET method, the contents of sulfur, and the contents of chlorine were measured. The results are shown in Table 3.

The average particle diameter was obtained by the laser light scattering method.

In addition, the contents of chlorine in the titanium titanates were measured by X-ray fluorescence analysis.

In addition, the contents of sulfur and niobium in the titanium titanates were measured by inductively coupled plasma atomic emission spectroscopy (ICP-AES).

TABLE 3

| | Average | | Content | Content | Content |
|---|---|---|---|---|---|
| | particle | BET specific | of | of | of |
| | diameter | surface area | sulfur | chlorine | niobium |
| | (μm) | (m²/g) | (ppm) | (ppm) | (ppm) |
| Example 1 | 1.2 | 8.2 | 127 | 18 | 47 |
| Example 2 | 0.9 | 5.1 | 127 | 18 | 47 |
| Example 3 | 0.8 | 3.1 | 126 | 18 | 47 |
| Example 4 | 0.4 | 9.8 | 494 | 14 | 546 |
| Example 5 | 0.6 | 4.9 | 494 | 14 | 546 |
| Example 6 | 0.8 | 3.1 | 494 | 14 | 546 |
| Example 7 | 1.3 | 8.0 | 1266 | 55 | 1588 |
| Example 8 | 1.5 | 4.1 | 1266 | 55 | 1588 |
| Example 9 | 1.2 | 3.2 | 1264 | 55 | 1585 |
| Example 10 | 1.2 | 5.9 | 127 | 18 | 202 |
| Example 11 | 1.1 | 5.8 | 127 | 18 | 202 |
| Example 12 | 1.2 | 8.2 | 127 | 18 | 202 |
| Comparative | 0.8 | 8.9 | 11 | 2765 | 246 |
| example 1 | | | | | |
| Comparative | 0.9 | 7.2 | 11 | 2765 | 246 |
| example 2 | | | | | |
| Comparative | 0.8 | 1.5 | 2586 | 460 | 460 |
| example 3 | | | | | |
| Comparative | 0.8 | 1.2 | 2586 | 460 | 460 |
| example 4 | | | | | |
| Comparative | 1.3 | 8.0 | 1267 | 1672 | 1589 |
| example 5 | | | | | |

### Battery Test

(1) Manufacturing of a Lithium Secondary Battery

The lithium titanates of Examples 1 to 12 and Comparative examples 1 to 5, which were manufactured in the above manner, were used as active materials, and 70 parts by weight of the lithium titanate, 15 parts by weight of acetylene black as a conducting agent, 15 parts by weight of polyvinylidene fluoride (PVDF) as a binding agent, and n-methyl-2-pyrrolidone as a solvent were mixed so as to prepare an electrode binder.

The electrode binder was coated on an aluminum foil by the doctor blade method so as to obtain a thickness of the dried coated film of 0.01 g/cm².

Next, the coated film was vacuum-dried at 150° C. for 24 hours, then subjected to roll pressing so as to obtain a thickness that was 80% of the thickness of the coated film immediately after coating, and punched out into an area of 1 cm², thereby producing a negative electrode of a coin battery.

A lithium secondary battery was manufactured by using the negative electrode, and members, such as a separator, the negative electrode, a positive electrode, a collector, mounting hardware, an external terminal, and an electrolytic solution. A metal lithium sheet was used as the positive electrode. A copper sheet was used as the collector. A polypropylene porous film was used as the separator. A solution of 1 mol/L of LiPF₆ dissolved in a volume mixing liquid, such as ethylene carbonate or ethyl methyl carbonate, was used as the electrolytic solution.

(2) Charge and Discharge Test

The respective coin batteries as manufactured in the above manner were subjected to three cycles in which the batteries were charged up to 1.0 V with a constant current having a current density of 0.2 C at 25° C., and then discharged to 2.0 V.

After that, the charge and discharge cycle was repeated three times at each of the current densities of discharge of 0.5 C, 1.0 C, and 2.0 C, and the maximum discharge capacity was used as the discharge capacity at each of the current densities. The results are shown in Table 4.

Meanwhile, in evaluation of the charge and discharge tests, a reaction in which lithium was inserted into the negative electrode active material was defined as charge, and a reaction in which lithium was separated was defined as discharge.

TABLE 4

| | Maximum discharge capacity | | | |
|---|---|---|---|---|
| | 0.1 C | 0.5 C | 1.0 C | 2.0 C |
| | (mAh/g) | (mAh/g) | (mAh/g) | (mAh/g) |
| Example 1 | 170 | 162 | 148 | 143 |
| Example 2 | 168 | 159 | 147 | 142 |
| Example 3 | 167 | 159 | 152 | 143 |
| Example 4 | 168 | 165 | 153 | 145 |
| Example 5 | 169 | 158 | 155 | 144 |
| Example 6 | 170 | 157 | 156 | 144 |
| Example 7 | 171 | 156 | 155 | 146 |
| Example 8 | 170 | 161 | 155 | 145 |
| Example 9 | 169 | 161 | 156 | 145 |
| Example 10 | 168 | 160 | 157 | 148 |
| Example 11 | 166 | 160 | 157 | 149 |
| Example 12 | 168 | 159 | 156 | 146 |
| Comparative | 164 | 145 | 142 | 132 |
| example 1 | | | | |
| Comparative | 164 | 145 | 140 | 135 |
| example 2 | | | | |
| Comparative | 164 | 143 | 139 | 132 |
| example 3 | | | | |
| Comparative | 165 | 148 | 139 | 135 |
| example 4 | | | | |
| Comparative | 164 | 143 | 140 | 130 |
| example 5 | | | | |

It was found from the results in Table 4 that the lithium secondary batteries in which the lithium titanates of Examples 1 to 11 were used as the negative electrode active materials had a large rapid charge and discharge capacity compared to the lithium secondary batteries in which the lithium titanates of Comparative examples 1 to 4 were used as the negative electrode active materials.

### INDUSTRIAL APPLICABILITY

According to the lithium secondary battery active material of the invention, since the lithium secondary battery active material is composed of lithium titanate which has a spinel structure, has a content of sulfate radicals of 100 ppm to 2500 ppm in terms of sulfur atoms and a content of chlorine of 1500 ppm or less, and is expressed by a general formula LiₓTi_{y}O₁₂ (however, in the formula, the atomic ratio of Li/Ti is 0.70 to 0.90, x satisfies 3.0≦x≦5.0, and y satisfies 4.0≦y≦6.0), it is possible to supply particularly excellent rapid charge and discharge characteristics to a lithium secondary battery in which the lithium secondary battery active material is used as a negative electrode active material.

1. A lithium secondary battery active material comprising lithium titanate which has a spinel structure, has a content of sulfate radicals of 100 ppm to 2500 ppm in terms of sulfur atoms and a content of chlorine of 1500 ppm or less, and is expressed by a general formula LiₓTi_{y}O₁₂ (however, in the formula, the atomic ratio of Li/Ti is 0.70 to 0.90, x satisfies 3.0≦x≦5.0, and y satisfies 4.0≦y≦6.0).

2. The lithium secondary battery active material according to claim 1,
wherein the lithium titanate preferably has a content of niobium of 50 ppm or more.

3. The lithium secondary battery active material according to claim 1,
wherein the lithium titanate preferably has an average particle diameter of 0.1 μm to 3.0 μm.

4. The lithium secondary battery active material according to claim 1,
wherein the lithium titanate preferably has a specific surface area by the BET method of 1.0 m²/g to 10.0 m²/g.

5. The lithium secondary battery active material according to claim 1,
wherein the lithium titanate is preferably generated by firing a mixture including a lithium compound and titanium dioxide obtained by a sulfuric acid method.

6. The lithium secondary battery active material according to claim 1,
wherein the lithium titanate is preferably generated by firing a mixture including a lithium compound, titanium dioxide obtained by a sulfuric acid method, and a sulfate of an alkaline earth metal.

7. The lithium secondary battery active material according to claim 6,
wherein the sulfate of an alkaline earth metal is preferably calcium sulfate or magnesium sulfate.

8. A lithium secondary battery,
wherein the lithium secondary battery active material according to claim 1 is used as a negative electrode active material.

9. A lithium secondary battery,
wherein the lithium secondary battery active material according to claim 2 is used as a negative electrode active material.

10. A lithium secondary battery,
wherein the lithium secondary battery active material according to claim 3 is used as a negative electrode active material.

11. A lithium secondary battery,
wherein the lithium secondary battery active material according to claim 4 is used as a negative electrode active material.

12. A lithium secondary battery,
wherein the lithium secondary battery active material according to claim 5 is used as a negative electrode active material.

13. A lithium secondary battery,
wherein the lithium secondary battery active material according to claim 6 is used as a negative electrode active material.

14. A lithium secondary battery,
wherein the lithium secondary battery active material according to claim 7 is used as a negative electrode active material.
